(19) United States
(12) Patent Application Publication
(10) Pub. No.: US 2012/0231390 A1
(43) Pub. Date: Sep. 13, 2012

(54) METHOD OF FIXING TONER IMAGE

(75) Inventors: Eiji Uekawa, Susono-shi (JP); Koichi Terauchi, Chiba-shi (JP); Satoru Izawa, Suntou-gun (JP); Katsuhiko Nishimura, Yokohama-shi (JP); Yukihide Ushio, Mishima-shi (JP); Ken-ichi Matsumoto, Tokyo (JP)

(73) Assignee: CANON KABUSHIKI KAISHA, Tokyo (JP)

(21) Appl. No.: 13/508,896

(22) PCT Filed: Nov. 9, 2010
(86) PCT No.: PCT/JP2010/006559

§ 371 Date: May 9, 2012

(30) Foreign Application Priority Data
Nov. 12, 2009 (JP) 2009-259026

(51) Int. Cl. G03G 13/20

(52) U.S. Cl. 430/124.1

(57) ABSTRACT

Energy consumption in a fixing process of an electrophotographic image-forming apparatus is reduced. An unfixed toner image T1 is fixed on a recording medium by applying a photopolymerizable composition D1 to the unfixed toner image T1 formed on the recording medium and then performing irradiation with light having a maximum emission wavelength in a wavelength range of from 420 to 470 nm using a light emitting diode or an organic EL device for curing the photopolymerizable composition D1 by photopolymerization.

### TECHNICAL FIELD

The present invention relates to a method of fixing a toner image by fixing an unfixed toner image formed on a recording medium to the recording medium.

### BACKGROUND ART

Recently, typical electricity consumption (TEC), an international energy star program, has been determined as a standard of energy saving in electrophotographic products, and it has been being introduced worldwide. The TEC value of a product represents a consumed power (kWh/week) that is consumed in a week (168 hours) consisting of five working days and two rest days when a job of printing a prescribed number of printings at a nominal rate is repeated a plurality of times at intervals of 15 minutes. Before the application of TEC, in many products, energy consumed during standby time (ready mode) and night and rest day time (sleep mode) was larger than the accumulated total energy consumed during printing time being about 30 sec/job and occupied most part of the TEC value. FIG. 2A shows a typical power profile during TEC measurement of a printer having a heat roller type fixing roller. In FIG. 2A, the horizontal axis represents time, and the vertical axis represents power consumption. The profile shows that the printer is maintained in the ready mode between the printing jobs that are performed at intervals of 15 minutes, the low-power mode enabling starting the job within 30 seconds during a predetermined period of time after the completion of the job, and the sleep mode after passing the predetermined period of time after the completion of the job.

The situation that the energy consumed in the ready mode and the sleep mode occupy most part of the TEC value has changed after 2007 when the application of TEC has been started. Now, many products enter the sleep mode about one minute after completion of printing, and the power during the sleep mode of so-called top runner products (products having most excellent energy saving performance at the same nominal rate) was decreased to 1 W, which may be said to be the lower limit. FIG. 2B shows a typical power profile during TEC measurement of a top runner printer having a thermo-fixing apparatus. It is characterized by that the job performed at intervals of 15 minutes is always started from the sleep mode, and the amount of power consumed during waiting, which conventionally occupied major part of the entire TEC value, has been noticeably reduced, and the TEC value has been almost occupied by the power consumed during job execution. The regulation of recovery time from the sleep mode, which was prescribed by the energy star program (objects are only monochrome copiers and multifunction printers) before the application of TEC, was abolished because of extension of objects to, for example, printers that are connected to networks. As a result, the period of time of a ready mode was reduced to the utmost limit, and it has been generalized to start printing job from the sleep mode. Consequently, the TEC value has been highly improved, but many products take 20 to 30 seconds as the recovery time for each job, which has an aspect of sacrificing usability.

The TEC value of a top runner of a color multifunction printer as a high-end machine (35-sheet machine) as of 2007 was 2.5 kWh/week, but the TEC value of a top runner as of 2009 was significantly reduced to 1.7 kWh/week. Even in a low-end machine, the TEC value of a top runner of monochrome 20-sheet printers as of 2007 was 1.0 kWh/week, but was reduced to 0.6 kWh/week as in 2009. The power consumption during the sleep mode of a top runner as of 2009 was 1 W in both color multifunction printers and monochrome printers, and the energy consumption during the sleep mode occupying the TEC value of such a printer is only 0.2 kWh/week at the highest.

A reduction in power consumed during printing job, which now occupies most of the TEC value, is only means for further reducing the TEC value. This is more severe in high-end machines where energy consumed in the printing job occupies a high ratio of the TEC value. It is thought that a further reduction in toner-fixing temperature is only possible means for energy saving in a thermo-fixing system. However, fixing at a low temperature of 20 to 30 degrees (Celsius) has been already performed as an energy-saving strategy, and a further reduction in temperature has an adverse effect of hardening toner at the time of transportation or using and is therefore highly difficult. Furthermore, even if the fixing temperature is reduced, its degree of energy saving is anticipated to be a reduction of about 10% of the TEC value at the highest. Accordingly, drastic energy saving by a system where a toner image is fixed without using heat is required. As a candidate, a photo-fixing system is gaining attention. A known photo-fixing technology will be described below.

Patent Literature 1 relates to an image-forming process where wear resistance and scratch resistance are improved by providing polymer coating having a three-dimensional cross-linking structure to a toner image formed by electrophotography. Specifically, the polymer coating composition includes (1) either a combination of siloxy-modified polycarbinol and acryl urethane or siloxy-modified acryl urethane and (2) a multifunctional acrylic acid compound as essential components. Furthermore, it is disclosed that the coating composition makes toner bind to an image-supporting material by curing. The term “curing” in Patent Literature 1 includes not only a case that a toner image is fixed with heat and then a coating composition is applied and cured by heat or light but also a case that a coating composition is directly applied to an unfixed toner image and is then cured by irradiation with ultraviolet light. As a specific example of the latter, in Example 1, the compounds (1) and (2) mentioned above are used, and a benzophenone-based compound is used as a polymerization initiator. The photo-curing process in this case is achieved using a high-pressure mercury lamp. The power consumption described in Example 1 is 118 W/cm, which is not low. The fixing rate corresponding to this is 30 mm/min (=500 mm/sec), which is a high speed. This is equivalent to an electricity of 3 to 4 kW, which is large as power consumed for fixing in a high-end electrophotographic image-forming apparatus and is far inferior to the recent power saving level. The mercury lamp having a large number of light emission lines also emits light having, for example, a wavelength in the infrared region, in addition to necessary ultraviolet, and is therefore not a power saving type. In addition, the mercury lamp needs a start-up time that is equivalent to or longer than that of a heat roller and tends to be large in size due to the constitution of the apparatus. Furthermore, the benzophenone-based photopolymerization initiator is effective for photo curing with the high-pressure mercury lamp having a large number of light emission lines, but has a problem that its sensitivity to a light source where the maximum emission wavelength is limited to a narrow wavelength region, such as an LED, is low.

In Patent Literature 2, a liquid composition where an unsaturated polyester resin serving as a photopolymerizable composition is dissolved in a vinyl monomer is applied, using a plurality of nozzles, to a recording medium on which an unfixed toner image is formed. Subsequently, the liquid composition is solidified by irradiation with ultraviolet for fixing between the toner particles and between the toner and the recording medium. The fixing process is disclosed together with a fixing process using, for example, warm air. Energy saving is stated as an effect of the fixation using the liquid composition, but it is described only that “when irradiation of ultraviolet was performed using an ultraviolet lamp, fixation could be achieved by a small amount of energy” as in the description of drying by warm air that “fixation could be achieved by a small amount of energy”. There is no citation of specific characteristics or a specific amount of consumed power of the ultraviolet light source for proving the above. Accordingly, since it is merely fixation using ultraviolet and is not believed to satisfy a level that is required at present, since the degree of energy saving is a level similar to that of the case using a heater utilizing its heat. In addition, waiting time, such as start-up time of the ultraviolet lamp, is not referred in the fixation using the ultraviolet lamp and also in other fixing processes described therein. It is easily presumed that a certain waiting time is needed, for example, when a heater is used, and, similarly, such a waiting time is also needed when an ultraviolet lamp is used.

The photopolymerizable composition of Patent Literature 2 is supplied by a feeding roll from a non-image portion of a recording medium, namely, from the rear surface, and it is necessary that the photopolymerizable composition surely penetrate and be supplied to a toner image formed on the front surface of the recording medium. Accordingly, a surfactant serving as a penetration-enhancing agent is used as a component of the photopolymerizable composition. However, the addition of the surfactant allows the photopolymerizable composition to surely penetrate into a deep portion of a recording medium or requires a large amount of the photopolymerizable composition to be applied to a recording medium (for example, plain paper). Therefore, the photopolymerizable composition penetrates into the fiber of the recording medium, and, thereby, ultraviolet light cannot sufficiently reach the inside of the fiber of the recording medium by usual irradiation. As a result, the photopolymerization is insufficiently performed to generate unreacted monomers and oligomers having low vapor pressures and cause an increase in volatile organic compounds (VOC). In addition, solidified substances polymerized in the inside of the fiber make the recording medium transparent, which significantly deteriorates the value of the image. Furthermore, the rigidity of the recording medium is increased to undesirably make the texture different from intrinsic one of plain paper for electrophotograph. When coated paper is used as a recording medium, the coating layer inhibits the photopolymerizable composition from penetrating. Therefore, complete polymerization cannot be expected, and it may be difficult to coat the toner image.

### CITATION LIST

### Patent Literature

PTL 1: U.S. Pat. No. 4,477,548
PTL 2: Japanese Patent No. 4014773

### SUMMARY OF INVENTION

### Technical Problem

The present invention provides a toner image-fixing process capable of significantly reducing energy necessary for fixing toner to a recording medium, compared to that of a thermo-fixing process.

### Solution to Problem

The toner image-fixing process of the present invention includes the steps of:

applying a photopolymerizable composition to an unfixed toner image formed on a recording medium; and

fixing the unfixed toner image to the recording medium by irradiating the unfixed toner image applied with the photopolymerizable composition with light having a maximum emission wavelength in a wavelength region of from 420 to 470 nm using a light emitting diode or an organic electroluminescent (EL) device for causing photopolymerization in the photopolymerizable composition to cure the photopolymerizable composition.

### Advantageous Effects of Invention

Since the step of fixing is performed by the photopolymerization without using heat, drastic energy saving can be achieved.

### BRIEF DESCRIPTION OF DRAWINGS

FIG. 1A is a cross-sectional view of a photo-fixing apparatus of Example 1.

FIG. 1B is a plan view of the photo-fixing apparatus of Example 1.

FIG. 2A shows the TEC value of a printer having a thermo-fixing roller.

FIG. 2B shows the TEC value of a top runner printer having a thermo-fixing apparatus.

FIG. 2C shows the TEC value of a printer having the photo-fixing apparatus of Example 1.

FIG. 3 is a graph showing the relationship between an absorption spectrum of a photopolymerization initiator and a light emission spectrum of an LED.

FIG. 4 is a diagram comparing the gamuts of a toner image fixed with a thermo-fixing apparatus and a toner image fixed with the photo-fixing apparatus of Example 1.

FIG. 5A is a schematic view illustrating a change in a toner layer when a photopolymerizable composition is applied.

FIG. 5B is a schematic view illustrating a change in the toner layer when the photopolymerizable composition is applied.

FIG. 5C is a schematic view illustrating a change in the toner layer when the photopolymerizable composition is applied.

FIG. 5D is a schematic view illustrating a change in the toner layer when the photopolymerizable composition is applied.

FIG. 6A is an entire cross-sectional view of a photo-fixing apparatus of Example 2.

FIG. 6B is a detailed cross-sectional view of the structure of a tubular member of the photo-fixing apparatus of Example 2.

FIG. 7 is a cross-sectional view of a photo-fixing apparatus of Example 3.

### DESCRIPTION OF EMBODIMENT

A photopolymerizable composition, a fixing light source, a toner, and an application process used in the embodiment will be described.

### Photopolymerizable Composition

A photopolymerizable composition utilizing any of the following three types of photopolymerization is used as the photopolymerizable composition. One is “radical photopolymerization” where active radical species are formed by irradiating a photopolymerization initiator with light and growth reaction is performed by sequentially polymerizing the active radical species with a monomer. The second is “cationic photopolymerization” where active cationic species are formed when a photopolymerization initiator, such as a sulfonium salt or iodonium salt, is excited with light and are sequentially polymerized with a monomer such as an epoxy compound, oxetane compound, or vinyl ether compound. The third is “anionic photopolymerization” where active anionic species generated by excitation with light are involved in polymerization. The “radical photopolymerization” includes a “Norrish I-type” reaction and a “Norrish II-type” reaction. In the “Norrish I-type” reaction, an alpha-hydroxy ketone, an alpha-aminoketone, BDK, an MAPO, or a BAPO is excited to an excited triplet state, and homolytic cleavage at the alpha-position generates active radical species. In the “Norrish II-type” reaction, a benzophenone is excited to an excited triplet state, and, at this state, hydrogen is extracted from the tertiary amine to cause polymerization of the generated active radical species with a monomer. The reaction of “radical photopolymerization” is readily inhibited by oxygen, but the radical photopolymerization is primarily employed because of its abundant monomer species.

In order to effectively perform curing of a photopolymerizable composition using a light emitting diode (LED), it is important to use a photopolymerizable composition containing a photopolymerization initiator having an absorption spectrum well matched to the emission spectrum of the LED. In particular, since the emission spectral band of the LED is narrow compared to that of a metal halide lamp or a medium- or high-pressure mercury lamp, the selection of the photopolymerization initiator is further important. Specific examples of the radical photopolymerization initiator include phosphine compounds, imidazole compounds, ketal compounds, and thioxanthone compounds. It is necessary that the photopolymerizable composition penetrates into an unfixed toner image layer and reaches the surface boundary between a toner and a recording medium, whereas the photopolymerizable composition is required not to penetrate into the recording medium and to cure on its surface, as far as possible. As an example of the method of achieving this, a monomer having high photopolymerization sensitivity or a multifunctional monomer is blended. The photopolymerizable composition may contain an additive such as a sensitizer, a viscosity modifier, or a rheology modifier may be blended. Furthermore, the obtained photopolymerized and cured product is necessary to be colorless and transparent, and the photopolymerizable composition may contain a filler of an inorganic or organic compound having a particle diameter of a nano order.

### Fixing Light Source

A light emitting diode or an organic EL device is used as the fixing light source for irradiating, with light, the unfixed toner image applied with the photopolymerizable composition. The light emitting diode can have a chip structure having a high emission efficiency. In general, when InGaN is used as a light emission layer, the emission wavelength can be changed from the infrared region to the ultraviolet region by changing the In composition. The emission efficiency is increased with the wavelength, and technologies for shifting the wavelength of an ultraviolet LED (hereinafter, referred to as UV-LED) having a maximum emission wavelength in the ultraviolet region toward the visible light region are developed. In the present invention, as the fixing light source for irradiating an unfixed toner image applied with the photopolymerizable composition with light, a light emitting diode or an organic EL device having a maximum emission wavelength in a wavelength region of from 420 to 470 nm is used. In particular, a light emitting diode or an organic EL device having a maximum emission wavelength in a wavelength region of from 420 to 470 nm, but substantially not having an emission wavelength band in the far-infrared region, can be used. Since the maximum emission wavelength is 420 nm or more, the emission efficiency is advantageously higher than that of ultraviolet light. Furthermore, in the case of ultraviolet light, it is necessary to use a lens that transmits ultraviolet, such as glass, as a condensing lens. However, a case using a visible light has a merit that a resin, which has higher versatility, can be used. On the other hand, for example, if the maximum emission wavelength is shifted to too longer wavelength, such as red light, the light energy itself is decreased to cause a necessity of extending the irradiation time. In addition, since it is necessary to absorb light having a long wavelength, the photopolymerizable composition is required to be colored, which causes a problem of varying the color of a toner image. Accordingly, the above-mentioned problems tending to occur due to the shift to the longer wavelength can be suppressed to the ranges that are not practical problems by setting the maximum emission wavelength of the LED to 470 nm or less and making the photopolymerization initiator have sensitivity in the wavelength range.

The power consumption of the LED or the organic EL device is smaller than that of the metal halide light source or the medium- or high-pressure mercury lamp, and is small in the device dimension and narrow in emission wavelength distribution. Since the LED and the organic EL device does not have emission spectra in the infrared region, the heat generated by them is small, which inhibits an increased in temperature of an apparatus. In addition, since the light emitting diode or the organic EL device having a maximum emission wavelength in a wavelength region of from 420 to 470 nm has a high emission efficiency, a light emission unit can be configured of the light-emitting elements arrayed in a line in the main-scanning direction and is provided with a simple heat-dissipating fin. The necessary emission intensity highly depends on sensitivity of the photopolymerizable composition, velocity of the electrophotographic image-forming apparatus, and also, for example, the distance (work distance) from the emission face to the irradiation face of an emission element, the type of a light guide, the type of a condensing lens, and presence or absence of use of a diffuser panel. In the embodiment, a light-emitting element having an irradiation intensity of from 400 to 2000 mW/cm² is used. On this occasion, the amount of light emitted by the light-emitting elements can be controlled independently for each element by controlling the respective current value, but the apparatus may be simplified and reduced in cost by collectively controlling current values of the entire elements.

As a light source substituting the LED, an organic EL device (OLED) can be used. Since the organic EL is a surface-emitting device, the processing and mounting of a light-emitting unit are significantly easy, compared to those of the LED, which is a point-emitting device. Even when the organic EL device is used, in particular, it is necessary to select a light source having a maximum emission wavelength in a region of from 420 to 470 nm and make it match with the absorption wavelength of the photopolymerization initiator.

### Toner

The toner used in the embodiment can be disposed in closest packing so that the space among toner particles on a recording medium is the smallest in order to hide the color of the recording medium itself and emphasize the color of coloring materials in the toner as much as possible. When a photopolymerizable composition is applied to a toner image having multiple layers formed on a recording medium, the photopolymerizable composition wets the surfaces of toner particles by capillary action and generates cohesive force among the toner particles and reaches the surface of the recording medium while filling the space among the toner particles with the liquid and penetrating among the toner particles. When the toner particles have uniform particle diameters and are spherical, the effect of the above-mentioned closest packing can be achieved. The term “spherical” used herein refers to a toner particle having a circularity ranging from 0.95 to 1.00 when measured with FPIA 3000, a product of Sysmex Corporation. The circularity can be determined using the following expression:

Circularity=(perimeter of a circle having the same area as that of a particle)/(perimeter of the particle).

The circularity of toner particles was measured using a dispersion of the toner particles prepared by adding 5 mg of the toner to 10 mL of water containing about 0.1 mg of a nonionic surfactant and subjecting the resulting mixture to dispersion for 5 minutes using an ultrasonic dispersion system. A completely spherical particle has a circularity of 1.00, and the circularity is decreased with an increase in the degree of complexity in shape. In particular, toner particles having a circularity of from 0.95 to 1.00 can be used. Furthermore, it is possible to control the permeability by generating an electroosmotic flow by applying an electric field to an electric double layer generated by the solid toner surface and the photopolymerizable composition.

Toner particles having a uniform particle diameter and a spherical shape can be produced by well known polymerization. As a method for producing toner particles having a uniform particle diameter and a spherical shape, a method utilizing interfacial tension in a liquid is superior, in energy for production and yield, to a method by pulverization requiring a large amount of energy for pulverization. In-situ polymerization directly producing a toner from a monomer can be particularly employed because of its energy-saving productivity. For example, a known method described in Japanese Patent No. 3066943 can be used. As a method of producing a toner, polymerization can be used from the viewpoints of production yield, production energy, and easy formation of spherical particles, but the method is not limited to the polymerization. A toner produced by pulverization and then subjected to thermal spheroidization can be also used.

In a fixation system using LED light, since heat generation is largely reduced, unlike known thermo-fixing systems, the heat-resistant member around the fixing apparatus can be changed to a general-purpose plastic material. In addition, the trade-off relationship in known toners that the fixing temperature of a toner having high durability is high and that the durability of a toner having low fixing temperature is low is eliminated. That is, even if a toner has high durability, it can be fixed using light. Therefore, since the problems around the fixing apparatus, which are caused by high-temperature setting, do not occur, both stabilization of the chargeability of a toner and cost down in the fixing apparatus can be simultaneously achieved.

### Application Process

The optimum amount of the photopolymerizable composition to be applied depends on the roughness and density of the surface of a recording medium or the time from the application till light irradiation. Usually, application in an amount to give a thickness of from 1 to 20 micrometer is suitable. Application to give a thickness larger than 20 micrometer causes curling of a recording medium or makes a recording medium transparent, which is disadvantageous. Application to give a thickness smaller than 1 micrometer causes a decrease in adhesive strength between a toner and a recording medium to make the fixing property insufficient such that falling of the toner is caused by, for example, rubbing or bending, which is disadvantageous. When a coated recording medium is used, the amount of a photopolymerizable composition to be applied is reduced, and a cationic photopolymerizable composition that is low in curing contraction is used. However, the cationic photopolymerizable composition is low in storage stability. Therefore, a radical photopolymerizable composition can be selected.

The photopolymerizable composition is applied by a known method for applying a medium- or low-viscosity material to form a thin layer. Examples of the method include methods using a rod coater, a gravure coater, a reverse gravure coater, a Mayer rod coater, a die coater, a kiss-roll coater, a single-fluid or double-fluid nozzle having a full cone nozzle, a flat spray nozzle, or a knife jet nozzle, or a roll coater; electric field atomization; and ink jet processes. The viscosity of a photopolymerizable composition is determined according to the method of application. The nozzle process and the ink jet process are highly suitable for controlling a very small amount of discharging, but since the driving force of a piezoelectric element is low, they can use for only a composition having a relatively low viscosity (e.g., from 10 to 30 mPas at 25 degrees (Celsius)). On the other hand, the method using a gravure coater or a roll coater and the heating ink jet process are suitable for a composition having a relatively high viscosity (e.g., from 30 to 400 mPas at 25 degrees (Celsius)). In order to cure the composition on the surface of a recording medium, a photopolymerizable composition having a medium degree of viscosity can be particularly used, rather than compositions having a low viscosity for penetration.

As described above, the present invention relates to a method of fixing an unfixed toner image onto a recording medium by applying a photopolymerizable composition to the unfixed toner image formed on the recording medium; and irradiating the unfixed toner image applied with the photopolymerizable composition with light having a maximum emission wavelength in a wavelength region of from 420 to 470 nm using a light emitting diode or an organic EL device for causing photopolymerization in the photopolymerizable composition to cure the photopolymerizable composition.

### Example 1

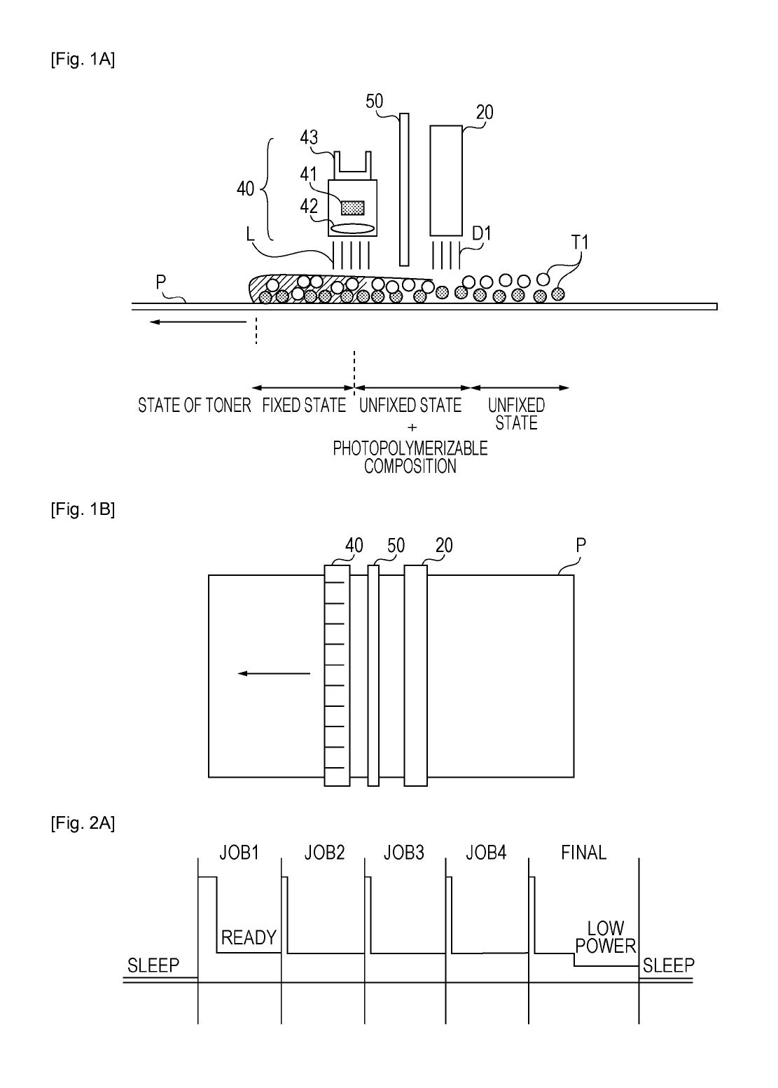

FIG. 1A is a cross-sectional view of a photo-fixing apparatus, and FIG. 1B is a plan view of the photo-fixing apparatus. This photo-fixing apparatus is mounted on a full-color electrophotographic laser printer (not shown) as an unfixed toner image T1 fixing apparatus. The photo-fixing apparatus includes an application portion 20 for applying a photopolymerizable composition D1 onto an unfixed toner image T1 formed on a recording medium P; a light-irradiating portion 40 for irradiating the unfixed toner image T1 applied with the photopolymerizable composition D1 with light L; and a light-shielding portion 50 for preventing the application portion 20 from being irradiated with the light L emitted by the light-irradiating portion 40.

The application portion 20 of Example 1 is an ink jet type and is provided with a plurality of ink jet nozzles (not shown) arranged in a line in the direction orthogonal to the direction of movement (the direction shown by the arrow) of the recording medium P. The ink jet nozzles may be each controlled independently in such a manner that the photopolymerizable composition D1 is applied onto only the area where the unfixed toner image T1 is formed on a recording medium. Alternatively, all the nozzles may be simultaneously controlled so that the photopolymerizable composition D1 is applied onto the entire area of the recording medium P. In the latter case, the wire connection between the nozzles and a nozzle-driving portion can have a simplified structure. In Example 1, UV or Visible Cure Adhesive LC1213 (250 to 380 nm, 400 to 500 nm), a product of 3M, was used as the photopolymerizable composition D1 to be applied onto the unfixed toner image T1 through the application portion 20. The photopolymerizable composition D1 has a relatively large viscosity of about 400 mPas at ordinary temperature. The photo-fixing apparatus of Example 1 has a heat source for heating and softening the photopolymerizable composition D1 to decrease the viscosity of the photopolymerizable composition D1 when it is discharged from the nozzles. The application area is not only the area where the unfixed toner image T1 is formed but the entire area of the recording medium, and the nozzles were controlled so that the thickness of the photopolymerizable composition D1 is uniform. The thickness of the unfixed toner image T1 consisting of multiple layers formed in the printer on a recording medium (in Example 1, Letter size plain paper having a basis weight of 75 g/m² was used) was about 25 micrometer in total, and the amount of the photopolymerizable composition D1 necessary for fixing the toner in this thickness was about 0.5 mL for the entire area of one sheet of the Letter size paper. This amount corresponds to an application thickness (the thickness when only the photopolymerizable composition D1 is applied onto a surface of a recording medium not allowing the photopolymerizable composition D1 to penetrate thereinto, such as a plastic film) of 8 to 10 micrometer. It has been experimentally confirmed in advance that the integrated amount of light necessary for curing the photopolymerizable composition D1 and fixing the toner to the recording medium with a sufficient strength is about 40 mJ/cm².

In the line-type light-irradiating portion 40 used in Example 1, twenty light emitting diode (LED) devices 41 are arrayed in a line in the main-scanning direction (the direction orthogonal to the direction of movement of the recording medium), and the line-type light-irradiating portion 40 is provided with a condensing lens 42 and a heat-dissipating fin 43. The LED devices may be each controlled independently so as to irradiate only the unfixed toner image T1 formed on a recording medium with light L. Alternatively, all the LED devices may be simultaneously controlled so as to irradiate the entire area of the recording medium P with light L. In the latter case, the wire connection between the LED devices and an LED-driving portion can be simplified to make the structure of the light-irradiating portion 40 simple.

The photopolymerizable composition D1 applied to the unfixed toner image T1 moves through the surfaces of toner particles, fills the space among the toner particles, and reaches the surface boundaries between the toner particles and the recording medium. The height (layer thickness) of the unfixed toner image T1 before the application of the photopolymerizable composition D1 is decreased by the action of surface tension caused by the application of the photopolymerizable composition D1. As a result, the relative positional relationship among toner particles varies to macroscopically accelerate color mixture (improve hue range).

Power consumption of the LED light source 41 is about 100 W in total, since power consumption of each LED device is about 5 W. The irradiation area has a length of 220 mm for covering the width of Letter size paper (215.9 mm (width)* 279.4 mm (length)) and a width of 10 mm in the recording medium-conveying direction. The LED light source 41 can irradiate this irradiation area with light having an average intensity of 500 mW/cm². The recording medium-conveying speed of the printer having the photo-fixing apparatus is about 100 mm/s, and the time necessary for passing the irradiation width of 10 mm in the conveying direction is 0.1 second. Therefore, the integrated amount of light obtained by passing under the LED light source is 50 mJ/cm². The irradiated light is LED light having a single maximum wavelength near 450 nm and ensures the integrated amount of light sufficient for fixing (about 40 mJ/cm²). These conditions could give a sufficient fixing strength. As the condensing lens 42, a usual resin lens can be used, unlike the case using ultraviolet light, resulting in an advantage of reducing the cost.

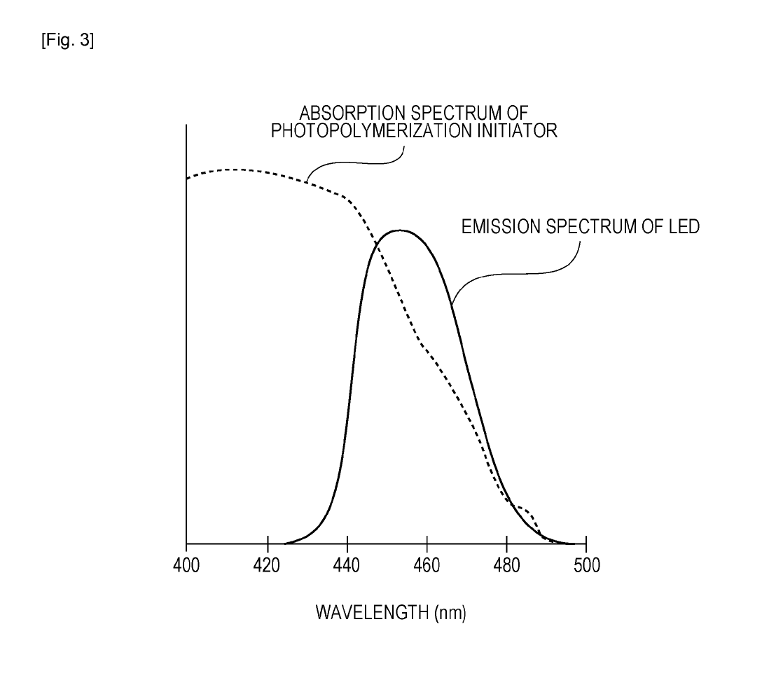

FIG. 3 shows the relationship between an absorption spectrum of a photopolymerization initiator contained in the photopolymerizable composition D1 used in Example 1 and a light emission spectrum of an LED. The absorption spectrum of the photopolymerization initiator can perform photopolymerization corresponding to light from 400 to 500 nm, and the emission wavelength distribution of the LED is concentrated in a narrow range of 40 nm around a center wavelength of 450 nm. Photopolymerization was efficiently caused in the photopolymerizable composition D1 filling space among the toner particles and also reached surface boundaries between the toner particles and the recording medium was efficiently photopolymerized to fix a toner image on the recording medium.

Fixing properties were evaluated by measuring the ratio of reduction in concentration when a toner image after fixing was rubbed. Specifically, image concentration after fixing is measured using a reflective concentration measuring apparatus, such as RD-19I, a product of GretagMacbeth. Subsequently, the image surface is rubbed with lens-cleaning paper a predetermined number of times, while being applied with a predetermined load using, for example, a weight. Furthermore, the concentration after rubbing is measured to calculate the ratio of reduction in concentration by the following expression:

(concentration reduction ratio:%)={(image concentration before rubbing)−(image concentration after rubbing)}/(image concentration before rubbing)*100

As shown in Table 1, the results confirmed that the fixing property in the photo-fixing was not inferior to that in the thermo-fixing. The comparison of reduction ratio of concentration was performed using a solid image and a halftone image of a monochrome black toner (K), and it is determined that a reduction ratio of concentration of 10.0% or less does not practically cause any problem. The unfixed toner image before fixing with a photo-fixing apparatus of Example 1 and the unfixed toner image before fixing with a thermo-fixing apparatus are the same.

TABLE 1
Comparison of reduction ratio of concentration

| | Reduction ratio of concentration | |
|---|---|---|
| | after rubbing | |
| | Example | Comparative Example |
| | (photo-fixing | (thermo-fixing |
| | system) | system) |
| K (solid portion) concentration | 1.2% | 4.6% |
| K (halftone portion) concentration | 1.2% | 4.8% |

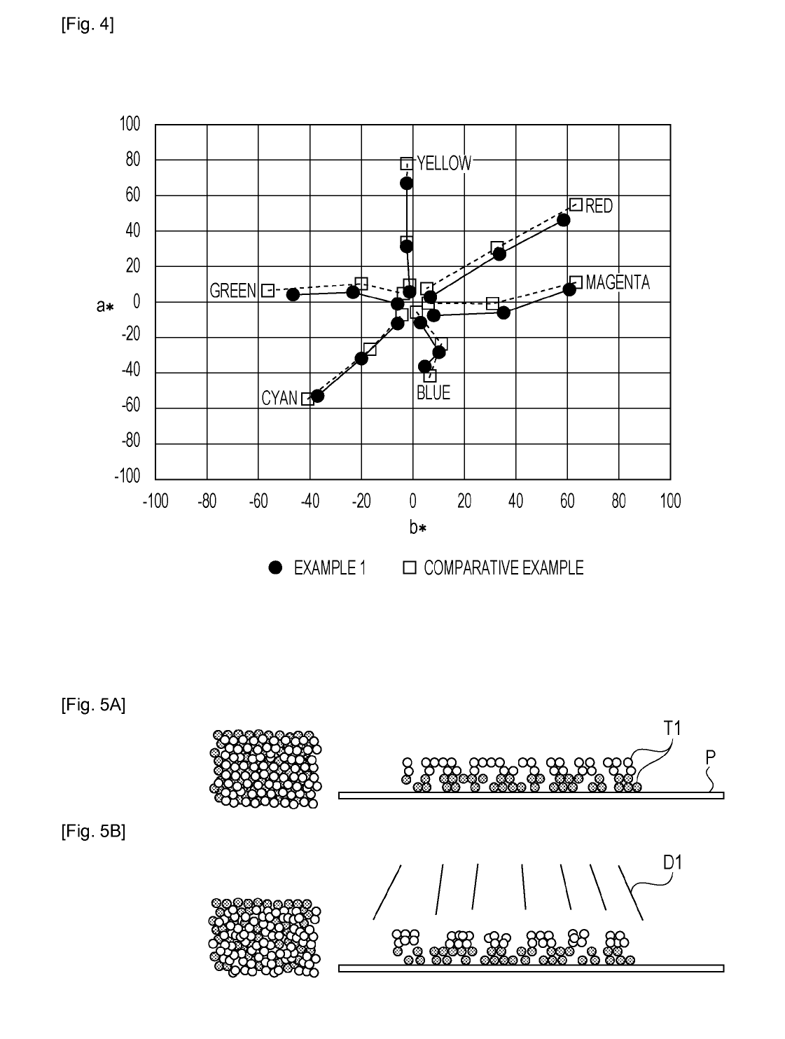

FIG. 4 shows color gamuts of toner images after fixing. The La*b* were measured using Spectrolino, a product of GretagMacbeth. The photo-fixing system of Example 1 is shown using a solid line, and the thermo-fixing system is shown using a broken line. It was confirmed that the photo-fixing system of Example 1 can perform sufficient color reproduction. This is because when the toner is in its unfixed state, light scattering at the surface boundary of the toner allows approximately only the color of the toner on the surface to enter the eyes of an observer, but light scattering is restricted by penetration of the photopolymerizable composition to accelerate optical absorption. Furthermore, observation by the present inventors revealed the action of juxtaposition color mixture, which is caused by switching of positions of toners having different colors between toner layers described below.

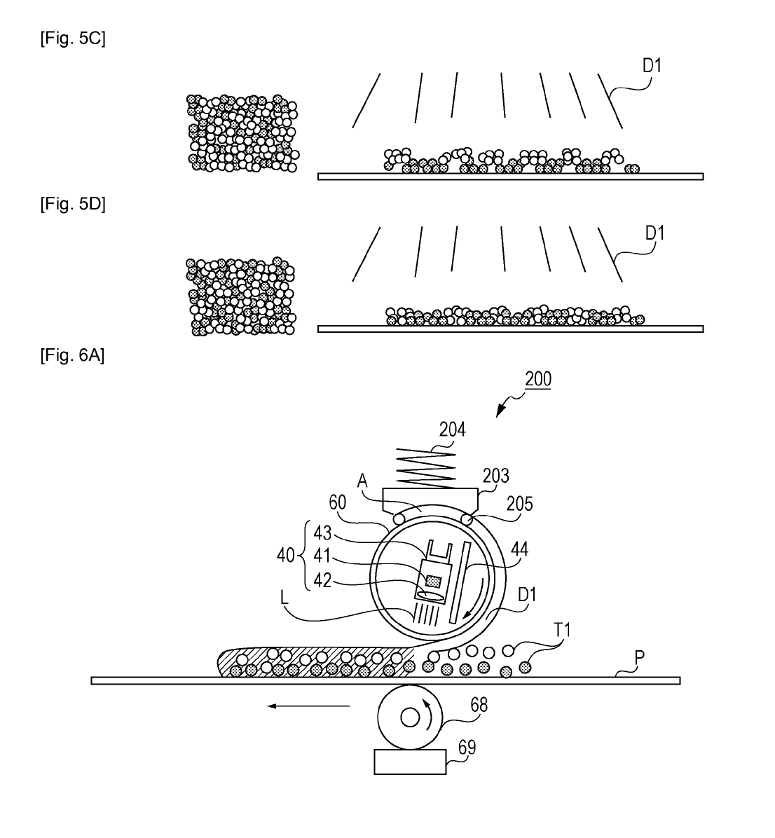

FIGS. 5A to 5D show the process of changes in positional relationship between toner particles, which occur in toner layers when the photopolymerizable composition D1 is applied onto a multi-color unfixed toner image T1 formed on a recording medium, from the state before application of the photopolymerizable composition D1 to the state after the application. FIG. 5A shows the state of a toner image where two colors are separated into upper and lower layers (an image formed by unfixed image-forming portion in a full-color laser printer).

As shown in FIG. 5A, in the two-color unfixed toner image (solid image) formed on the recording medium, the lower layer of the first color toner and the upper layer of the second color toner are laminated in layers. The toner layer of each color has a thickness of 1.5 to 3 times the toner particle diameter, and the two color toners form about three to six toner particle layers. The color of the toner of the upper layer is dominant as the color of the image recognized at this unfixed state. In the case shown in FIG. 5A, the magenta color is dominant, and cyan color in the lower layer is reflected from the portions where the number of the magenta toner particles is small or the magenta toner particles are not present. As a result, a color of magenta with a slightly bluish tone (secondary color) is visually recognized by an observer.

Subsequently, application of the photopolymerizable composition D1 from the above to the unfixed toner image is started, and then, as shown in FIG. 5B, clusters originating from portions where liquid droplets adhere to and penetrate among the toner particles are formed by agglomeration of the toner particles with surrounding toner particles due to interface tension of the liquid. The size of the clusters varies depending on, for example, the size of the droplets, but clusters are distributed at approximately the same intervals. The color of the image recognized in this state is gradually changed to a color affected by the color of the lower layer by that gaps among the clusters broaden due to the agglomeration of the toner of the upper layer in the planar direction to allow reflection intensity from the toner of the lower layer to be high, compared to that before the application of the photopolymerizable composition D1.

Furthermore, according to proceeding of the application of the photopolymerizable composition D1, as shown in FIG. 5C, the photopolymerizable composition D1 directly adheres to and penetrate among the toner particles of the lower layer through the gaps formed among clusters of the toners of the upper layer, and the toners of the lower layer agglomerate and start to form clusters, as in the toners of the upper layer. At the same time, the toner in the state of clusters having various sizes in the upper layer, where the penetration of the photopolymerizable composition D1 has proceeded, is attracted toward the recording material direction (downward direction of FIG. 5C) by the effects of the penetration of the photopolymerizable composition D1 and the interface tension. The gaps and spaces present between the toners are reduced by intervention of the photopolymerizable composition D1, and the toner layers are reduced in the thickness and are uniformized, compared to the thickness of the toner layers before the application of the photopolymerizable composition D1.

Eventually, by the completion of the application of a predetermined amount of the photopolymerizable composition D1, as shown in FIG. 5D, clusters of each color toners in various sizes and clusters of mixed two color toners in various sizes are generated at approximately the same intervals. Thus, the toner particles are highly changed in their alignment, compared to the toner alignment of the initial state (unfixed state), and a state that the penetrated photopolymerizable composition D1 has reached the surface of the recording medium is formed. In microscopic observation, color mixture of the thermo-fixing system, that is, color mixture caused by fusion of toners having different colors, does not occur (microscopically, the state is not a secondary color), but the color of the image in this state can be recognized as a color image not being inferior to color mixture state obtained by the thermo-fixing system by that juxtaposition color mixture is formed by laying the clusters together, the clusters having sizes that are sufficiently smaller than spatial resolution performance of human eyes.

Note that the mechanisms of the juxtaposition color mixture and color mixture acceleration of the color toners caused by switching of toner positions between the above-described toner layers occur in the process of the photopolymerizable composition D1 application. This is not limited to light in the visible light region of from 420 to 470 nm, which has been shown in Example 1, and is a phenomenon that can also be observed when fixing is performed using ultraviolet light having shorter wavelength.

The driving electricity for light irradiation using an LED light source of Example 1 is 100 W as actual measurement, and the driving electricity as a fixing apparatus including the photopolymerizable composition D1 application portion (heat-type ink jet head) is approximately 180 W. The electricity is shown in Table 2, compared to that when fixing is performed by the thermo-fixing system.

TABLE 2
Comparison of power consumption

| | LED | Application | |
|---|---|---|---|
| | driving | apparatus driving | |
| | power | power | Total |
| Example | 100 W | 80 W | 180 W |
| (photo-fixing | | | |
| system) | | | |
| | Heater heating | Apparatus driving | |
| | power | power | Total |
| Comparative | 300 W | 5 W | 305 W |
| Example | | | |
| (thermo-fixing | | | |
| system) | | | |

As obvious from Table 2, the power consumption of the fixing apparatus of Example 1 is 180 W and is about 60% of the power consumption when a thermo-fixing method is used. The light conversion efficiency of the LED light source is about 10% or less. It is anticipated that the power consumption necessary for driving the light source can be further reduced by further improving the conversion efficiency of the LED in the future, and the photo-fixing method is thought as a fixing-method having high potential electricity saving in the future.

A thermo-fixing apparatus or a photo-fixing apparatus of Example 1 was mounted on a monochrome laser printer capable of outputting A4 size paper at 16 sheets/min in longitudinal feeding, and TEC values as an electrophotographic printer were compared. The results are shown in Table 3. The TEC value of Comparative Example in Table 3 is a top-runner level as of 2009, and a controller allowing the power consumption in its sleep mode to be 1 W is used. The comparative values are those measured by changing only the thermo-fixing apparatus of the printer to a photo-fixing apparatus.

TABLE 3
Comparison of TEC value (1)
A4 monochrome printer (A4 longitudinal: 16 sheets/min)

| | | | | total TEC |
|---|---|---|---|---|
| | 1 W sleep | Fixing | Other | value |
| | energy | energy | energy | KWh/week |
| Example | 0.17 | 0.12 | 0.14 | 0.43 |
| | | (180 W) | | |
| Comparative Example | 0.17 | 0.21 | 0.14 | 0.52 |
| | | (305 W) | | |

The TEC value depends on speed, and the energy-saving effect when the thermo-fixing apparatus is changed to the photo-fixing apparatus is significantly achieved with an increase in the speed. An effect of decreasing the TEC value when the photo-fixing apparatus of Example 1 is applied to a high-end product of A3 color multifunction printer (printer performance: outputting at 51 sheets/min in A4 transverse feeding) will be described below. The TEC value of this Comparative Example is a top-runner level as of 2009, and a controller allowing the power consumption in its sleep mode to be 1 W is used.

TABLE 4
Comparison of TEC value (2)
A3 color multifunction printer (A4 transverse: 51 sheets/min)

| | | | | total TEC |
|---|---|---|---|---|
| | 1 W sleep | Fixing | Other | value |
| | energy | energy | energy | KWh/week |
| Example | 0.17 | 1.13 | 0.85 | 2.15 |
| Comparative Example | 0.17 | 1.98 | 0.85 | 3.0 |

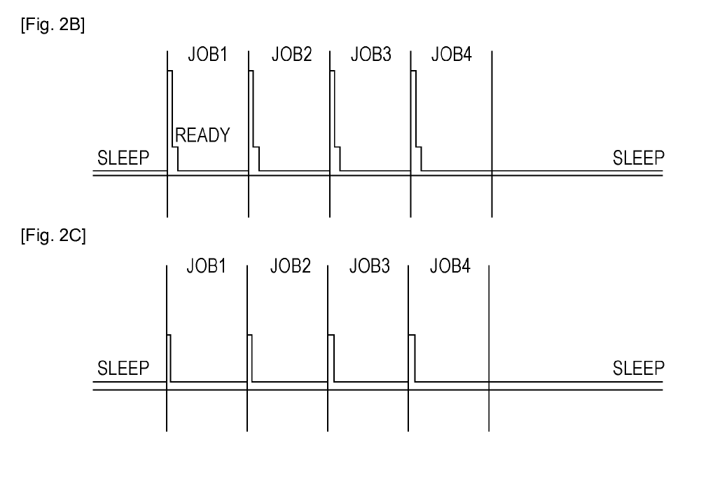

The thermo-fixing system has been recognized that it is difficult to further reduce the fixing temperature of a toner, but even if the fixing temperature is decreased, the effect of reducing the TEC value is estimated to be about 10%. Based on this, it can be understood that the decreases in the TEC value of 17 to 28% by the photo-fixing apparatus of Example 1, shown in Tables 3 and 4, are a very large energy-saving effect. Furthermore, it is forecasted that the light source efficiency of the LED is increased in the future. In such occasion, the fixing energy is further decreased, and further energy saving can be expected. FIG. 2C shows a power profile when TEC value of a printer having the photo-fixing apparatus of Example 1 was measured. It is confirmed that the energy consumed for printing is lower than that in Comparative Example shown in FIG. 2B.

As another configuration of Example 1, an organic EL device may be used as a light source, instead of the LED light source. For example, a rectangular parallelepiped light emitting source prepared by cutting out a surface-emitting body composed of an organic EL device having a peak wavelength near 440 nm and subjecting it resin sealing is used. The irradiation area is adjusted so that the main-scanning direction covers the Letter size width (215.9 mm) and the sub-scanning direction covers a width of 10 mm. When the organic EL device having an irradiation intensity of 500 mW/cm² was fully lighted, a fixed image similar to that obtained when the LED light source was used could be obtained at a power consumption of 130 W. Even in this case, a large amount of energy saving can be achieved, compared to Comparative Example (thermo-fixing system).

### Example 2

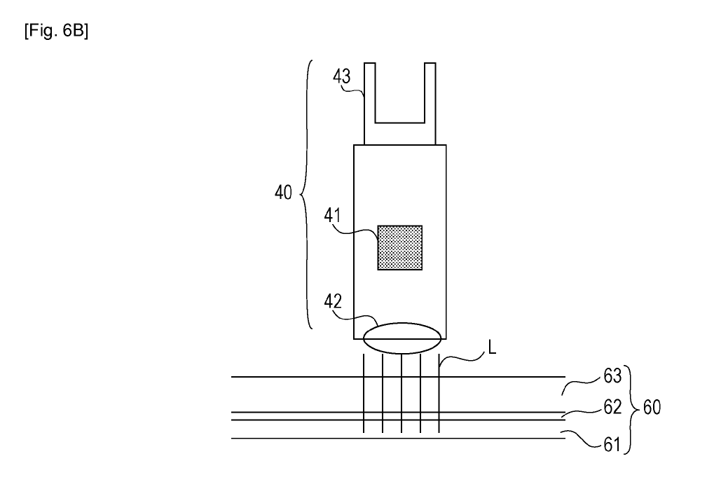

FIG. 6A shows an entire cross-sectional view of a photo-fixing apparatus of Example 2, and FIG. 6B shows a detailed cross-sectional view of the structure of a tubular member. This photo-fixing apparatus 200 includes a rotatable tubular member 60, a supply portion (203, 205) for supplying the photopolymerizable composition D1 to the surface of the tubular member 60, and a light emitting diode 41 arranged inside the tubular member 60. The tubular member 60 applies the photopolymerizable composition D1 supplied to its surface, while rotating, to the unfixed toner image T1 on a recording medium P. The unfixed toner image T1 applied with the photopolymerizable composition D1 is irradiated with light using the light emitting diode through the tubular member 60 for causing photopolymerization of the photopolymerizable composition D1 and thereby curing the photopolymerizable composition D1 to fix the unfixed toner image T1 to the recording medium P.

Specifically, the photo-fixing apparatus 200 has the same structure as that of a simple roll coater disclosed in Japanese Patent Laid-Open No. 2005-254803, and includes an application roller (tubular member) 60, a space-forming base material 203 disposed on the upper portion of the application roller 60, a ring-shaped elastic sealing member 205, and a biasing means 204. By biasing the space-forming base material 203 with the biasing means 204, a space A surrounded by the space-forming base material 203, the application roller 60, and the elastic sealing member 205 is formed. The photopolymerizable composition D1 is supplied to this space A from a supply hole (not shown) provided to the space-forming base material 203 and is held in the space A. The photopolymerizable composition D1 is supplied to the space A with a pump, and the photopolymerizable composition D1 is supplied to or collected from the space A by adjustment according to the rotation of the application roller 60 or stoppage thereof. In the state that the application roller 60 is stopped, the application roller 60 and the elastic sealing member 205 are in contact with each other. Even if a tiny gap is formed between them, the liquid (photopolymerizable composition) will not leak from the space A, due to the surface tension of the photopolymerizable composition D1. When the application roller 60 is rotated, the photopolymerizable composition D1 is supplied to the surface of the application roller 60 at a constant amount. A recording medium P applied with the unfixed toner image T1 is conveyed between the application roller 60 and a back-up roller 68, and, at the same time, the photopolymerizable composition D1 is applied to the unfixed toner image T1.

The photopolymerizable composition D1 used in Example 2 is the same as that used in Example 1, but, in the roll coating, even if the photopolymerizable composition D1 has a viscosity higher than that when it is used in the application using an ink jet apparatus, the photopolymerizable composition D1 can be applied without decreasing the viscosity. In Example 2, the photopolymerizable composition D1 could be applied on the application roller 60 so as to have a thickness of from 5 to 10 micrometer by the above-mentioned method.

As shown in FIG. 6B, the application roller 60 has a base layer 63, an elastic layer 62, and a surface-releasing layer 61. The surface-releasing layer 61 is a tetrafluoroethylene-perfluoroalkyl vinyl ether copolymer (PFA) layer having a thickness of about 30 micrometer. The intermediate elastic layer 62 is made of THV 220, a product of Sumitomo 3M Ltd. The base layer 63 is transparent polyimide (PI) pipe having a thickness of 2 mm. Each layer of the application roller 60 is formed of materials that transmit the LED light having a maximum emission wavelength in the wavelength range from 420 to 470 nm.

The light-irradiating portion 40 having LEDs 41 arranged in line is disposed inside the hollow application roller 60 and has a structure such that the irradiation area has a nip width of 10 mm, and irradiation can be performed to the entire longitudinal direction of A4 size recording medium. The heat sink 43 also has a function as a holding member for holding the light-irradiating portion 40 to the frame of the photo-fixing apparatus 200. The light emitted from the light-irradiating portion 40 is irradiated toward the unfixed toner image T1 after being applied with the photopolymerizable composition D1. Therefore, the light-irradiating portion 40 is tiltingly attached inside the application roller 60 so as to irradiate light on the downstream side in the conveying direction of the recording medium P than the position where the photopolymerizable composition D1 is applied to the unfixed toner image T1 from the application roller 60. A light-shielding member 44 is disposed between the light-irradiating portion 40 and the application roller 60 so as to prevent the photopolymerizable composition D1 on the application roller from being directly irradiated with the LED light.

The application roller 60 is driven to rotate in the direction indicated by the arrow by a driving unit (not shown), and a pressure roller 68 is dependently rotated in the direction indicated by the arrow. The recording medium P provided with the unfixed toner image T1 is interposed between the application roller 60 and the pressure roller 68, and the unfixed toner image after being applied with the photopolymerizable composition D1 is irradiated with the LED light to fix the unfixed toner image to the recording medium P. The cured photopolymerizable composition D1 by the irradiation with light is transferred to the recording medium P due to the function of stress-strain generated between the application roller 60 and the pressure roller 68 and is almost not left on the surface of the application roller 60. In FIG. 6A, the photopolymerizable composition D1 transferred to the pressure roller 68 is removed by a photopolymerizable composition D1 scraping member 69. The supplying method of the photopolymerizable composition D1 to the application roller 60 is not limited to the method using the elastic sealing member 205, and the photopolymerizable composition D1 may be supplied to the application roller 60 using a pad impregnated with the photopolymerizable composition D1 or continuous webs.

The above-described simple roll coater 200 is driven at a process rate of 100 mm/sec to irradiate the photopolymerizable composition D1 penetrated into the unfixed toner image T1 with light emitted by the same LED light source as that in Example 1. As a result, an image having sufficient fixing property and wear resistance that are equivalent to those shown in Example 1 was obtained. In Example 2, since preheating of the photopolymerizable composition D1, which was necessary in the ink jet coating, was unnecessary, the power consumption necessary for fixing was reduced from 180 W to 120 W. The TEC values measured as in Example 1 were 0.39 kWh/week in a monochrome printer and 1.93 kWh/week in a color multifunction printer. Thus, the reduction ratios of TEC value are 25 to 36%.

Thus, the photo-fixing apparatus in Example 2 includes a rotatable tubular member, a supply portion for supplying a photopolymerizable composition to the surface of the tubular member, and a light emitting diode or an organic EL device disposed inside the tubular member. The tubular member applies the photopolymerizable composition supplied on the surface thereof to an unfixed toner image on a recording medium while rotating; the unfixed toner image applied with the photopolymerizable composition is irradiated with light through the tubular member using the light emitting diode or the organic EL device for causing polymerization in the photopolymerizable composition and thereby curing the photopolymerizable composition to fix the unfixed toner image to the recording medium.

Note that LEDs or organic EL devices that emit ultraviolet light can be used as light sources by forming the surface-releasing layer 61, the elastic layer 63, and the base material layer 63 used in the application roller 60 disclosed in Example 2 by materials transmitting ultraviolet light and changing the condensing lens 42 to glass transmitting ultraviolet light.

### Example 3

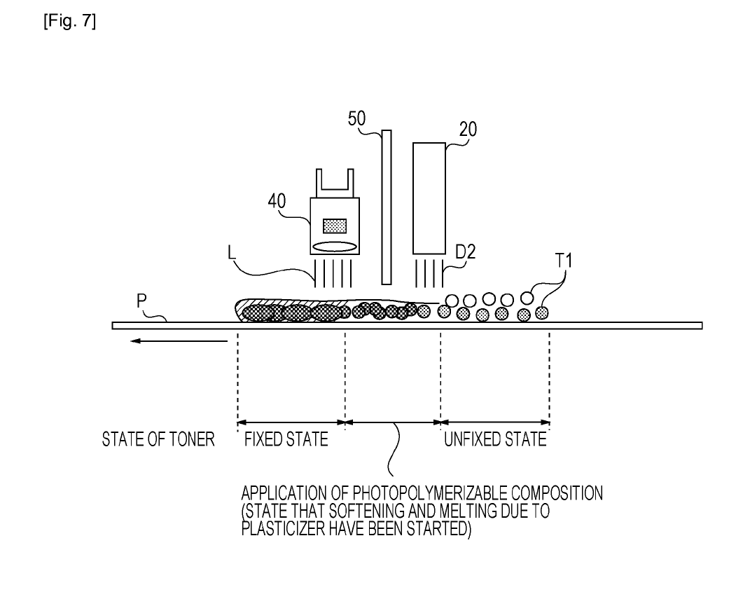

FIG. 7 shows a fixing process of Example 3 of the present invention. This Example is different from Example 1 in that the photopolymerizable composition D2 applied to the unfixed toner image T1 contains not only the photopolymerization initiator but also a plasticizer. This process has a merit that by applying the photopolymerizable composition D2 containing the plasticizer to the unfixed toner image T1, the toner can be photopolymerized while being softened and melted to accelerate color mixture of the toner.

Various plasticizers can be used. In Example 3, an aliphatic ester plasticizer was used. The aliphatic ester plasticizer is (1) an ester of a fatty acid and an alcohol compound or (2) an ester of an aliphatic alcohol and an acid, and examples thereof include aliphatic diacid esters such as diisodecyl succinate, dioctyl adipate, diisodecyl adipate, dioctyl azelate, dibutyl sebacate, dioctyl sebacate, dioctyl tetrahydrophthalate, and dibutoxyethyl adipate. These can enhance the compatibilizing effect. The content of the aliphatic ester plasticizer is in the range of from 0.5 to 75 parts by weight, preferably from 1 to 50 parts by weight, and more preferably from 2 to 30 parts by weight, based on 100 parts by weight of the photopolymerizable composition. If the content is too small, the plasticizing effect on the toner is low; and if the content is too large, the photo-curing function may be decreased.

FIG. 7 shows the fixing process of Example 3. Descriptions of the same portions as in Example 1 are omitted. In FIG. 7, application of the photopolymerizable composition D2 to the unfixed toner image T1 by an application apparatus 20 is started. After the application, the toner layers start to be softened and melted by the effect of the plasticizer during the unfixed toner image T1 reaches the light-irradiating portion 40. Penetration of the photopolymerizable composition D2 to the toner layers and softening and fusion of the toner are accelerated by the function of the plasticizer, before that the unfixed toner image T1 reaches the light-irradiating portion 40. Then, curing polymerization starts by light-irradiation with the LED, and at the time of being discharged from the fixing apparatus after completion of the curing of the photopolymerizable composition, the toner layers are reduced in the thickness thereof, and the toner is fixed to a recording medium in the melted state.

Thus, in Example 3, an unfixed toner image is fixed to a recording medium by softening the toner by applying a photopolymerizable composition containing a plasticizer to the unfixed toner image formed on the recording medium; and irradiating the unfixed toner image applied with the photopolymerizable composition with light using a light emitting diode or an organic EL device for causing photopolymerization in the photopolymerizable composition to cure the photopolymerizable composition. By doing so, since color mixture is enhanced, more uniform color mixture is possible, the fixing property is improved, and a toner image having higher gloss can be obtained. Since the LED or the organic EL device is used as a light source also in Example 3, as described in Example 1, a large amount of energy saving can be achieved, compared to the case using the thermo-fixing apparatus. In addition, in Example 3 as in Example 2, an LED or an organic EL device that emits ultraviolet light can be used as the light source.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-259026, filed Nov. 12, 2009, which is hereby incorporated by reference herein in its entirety.

1. A method of fixing a toner image, comprising:
applying a photopolymerizable composition to an unfixed toner image formed on a recording medium; and
fixing the unfixed toner image to the recording medium by irradiating the unfixed toner image applied with the photopolymerizable composition with light having a maximum emission wavelength in a wavelength range of from 420 to 470 nm using a light emitting diode or an organic EL device for causing photopolymerization in the photopolymerizable composition to cure the photopolymerizable composition.

2. The method according to claim 1, wherein the toner has a circularity of from 0.95 to 1.00.
